(19) United States
(12) Patent Application Publication
(10) Pub. No.: US 2023/0183609 A1
(43) Pub. Date: Jun. 15, 2023

(54) FABRIC SOFTENER COMPOSITION

(71) Applicant: Conopco, Inc., d/b/a UNILEVER, Englewood Cliffs, NJ (US)

(72) Inventors: Girish MURALIDHARAN, Bangalore (IN); Gaurav PATHAK, Bangalore (IN); Rajeesh Kumar RAMACHANDRAN, Bangalore (IN); Dhanalakshmi THIRUMENI, Bangalore (IN)

(21) Appl. No.: 17/925,495

(22) PCT Filed: Apr. 28, 2021
(86) PCT No.: PCT/EP2021/061181

§ 371 Date: Nov. 15, 2022

(30) Foreign Application Priority Data
May 27, 2020 (IN) 202021022249
Jul. 15, 2020 (EP) 20186061.6

(51) Int. Cl. C11D 3/00; C11D 11/00; C11D 17/00; C11D 3/50; C11D 3/30; C11D 3/37; C11D 3/10; C11D 3/20; C11D 3/22

(52) U.S. Cl. CPC C11D 3/001; C11D 11/0017; C11D 17/0086; C11D 11/0082; C11D 3/505; C11D 3/30; C11D 3/37; C11D 3/10; C11D 3/2086; C11D 3/222

(57) ABSTRACT

A solid fabric softening composition comprising; fabric softening active, co-active and disintegrant system, wherein the disintegrant system comprises salt and acid.

### FIELD OF INVENTION

The present invention is in the field of solid fabric conditioners which are in the form of a solid, preferably a tablet.

### BACKGROUND OF INVENTION

Consumers are becoming more conscious of the environmental impact of the products they use. In particular, consumers are concerned with the vast amounts of packaging used in their everyday lives. There is a need for more concentrated products which can provide the same consumer benefits, but with a lower environmental impact.

One solution is to use solid products which have the dual benefit of firstly not requiring the transport of large quantities of water and secondly having reduced packaging requirements.

Laundry detergent tablets are commonly used by consumers. These are added directly into the drum of a washing machine and deliver detergency during the wash stage of the laundry process. The use of solid tablets in the rinse however presents a number of difficulties. A tablet intended for the rinse cannot be dosed in the drum of a front loading washing machine, since it would dissolve in the main wash and would not survive until the rinse process. If a solid tablet is placed in the drawer of an automatic washing machine, it is subject to very challenging conditions. The tablet must dissolve in low quantities of water, with low agitation, over a short period of time and without leaving residues which could block the syphon in the rinse drawer. Not only is dissolution important, but the tablet must also provide the consumers with the softening performance which they have grown accustomed to. This presents a further problem to be addressed since it is known in the art that that common fabric softening actives are prone to gelling on dilution, which would lead to unsuitable viscosities which could not be flushed through the syphon of the rinse drawer.

Taking all of this into account, there is a need for solid fabric softening compositions, which are suitable for preparation as a tablet. The tablet being able to dissolve in the rinse drawer of a washing machine, to not leave residues and to provide fabric softening benefits.

### SUMMARY OF INVENTION

In a first aspect of the present invention is a solid fabric softening composition comprising:
a. 25 to 70 wt. % Fabric softening active;
b. Co-active; and
c. Disintegrant system;

Wherein the disintegrant system comprises salt and acid.

In a second aspect of the present invention is a method of producing a fabric softening tablet, the method comprising the steps of;
i. Melting a fabric softener active and a co-active in a pre-melt;
ii. Combining the pre-melt with a disintegrant system; and
iii. Compressing the resulting powder into a tablet.

In a third aspect of the present invention is a method of softening clothes, wherein a solid fabric softening composition as described herein, is placed in the rinse drawer of an automatic washing machine.

In a fourth aspect of the present invention is a use of a solid fabric softening composition as described herein, wherein the composition is used to soften fabrics during the rinse stage of the laundry process.

### DETAILED DESCRIPTION OF THE INVENTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### Softening Active

The solid fabric softening composition of the present invention comprises 25 to 70 wt. % softening active. Preferably the composition comprises more than 35 wt. % fabric softening active, most preferably more than 40 wt. % fabric softening active. The solid fabric softening composition of the present invention preferably comprise less than 60 wt. % fabric softening active, most preferably less than 55 wt. % fabric softening active. The solid fabric softening composition comprises 25 to 70 wt. % fabric softening active, preferably 35 to 60 wt. % fabric softening active and most preferably 40 to 55 wt. % fabric softening active.

Suitable fabric softening actives may preferably be selected from a quaternary ammonium compounds having more than one long carbon chain, cationic polymers, glycerides, clays and combinations thereof. Preferred softening actives are a quaternary ammonium compounds having more than one long carbon chain.

A suitable fabric softening active may be a cationic polymer. Suitable cationic polymers typically contain cationic nitrogen-containing groups such as quaternary ammonium or protonated amino groups. The cationic protonated amines can be primary, secondary, or tertiary amines (preferably secondary or tertiary).

The average molecular weight of the cationic polymer is preferably from 5,000 to 10 million. The cationic polymer preferably has a cationic charge density of from 0.2 meq/gm to 7 meq/gm. The term “cationic charge density” in the context of this invention refers to the ratio of the number of positive charges on a monomeric unit of which a polymer is comprised to the molecular weight of the monomeric unit. The charge density multiplied by the polymer molecular weight determines the number of positively charged sites on a given polymer chain.

The cationic nitrogen-containing moiety of the cationic polymer is generally present as a substituent on all, or more typically on some, of the repeat units thereof.

The cationic polymer may be a homo-polymer or co-polymer of quaternary ammonium or cationic amine-substituted repeat units, optionally in combination with non-cationic repeat units. Particularly suitable cationic polymers for use in the invention include cationic polysaccharide polymers, such as cationic cellulose derivatives, cationic starch derivatives, and cationic guar gum derivatives.

A particularly suitable type of cationic polysaccharide polymer that can be used is a cationic guar gum derivative, such as guar hydroxypropyltrimethylammonium chloride, (commercially available from Rhodia® in their JAGUAR® trademark series). Examples of such materials are JAGUAR® C13S, JAGUAR® C14, JAGUAR® C15 and JAGUAR® C17.

Suitable further cationic polymers include, for example, copolymers of vinyl monomers having cationic amine or quaternary ammonium functionalities with water soluble spacer monomers such as (meth)acrylamide, alkyl and dialkyl (meth) acrylamides, alkyl (meth)acrylate, vinyl caprolactone and vinyl pyrrolidine. The alkyl and dialkyl substituted monomers preferably have C1-C7 alkyl groups, more preferably C1-3 alkyl groups. Other suitable spacers include vinyl esters, vinyl alcohol, maleic anhydride, propylene glycol and ethylene glycol.

A further group of suitable cationic polymers are cationic proteins. For example cationic derivatives of insulin, such as quatin 350 and quatin 680 ex Cosun Biobased products.

A suitable fabric softening active may be a quaternary ammonium compounds (QAC) having more than one long carbon chain, i.e. more than one carbon chain of 10 carbon atoms or more in length. These compounds comprise at least two chains derived from a fatty acids. Generally fatty acids are defined as aliphatic monocarboxylic acids having a chain of 4 to 28 carbons. Preferably the fatty acid chains are palm or tallow fatty acids. Preferably the fatty acid chains of the QAC comprise from 10 to 50 wt. % of saturated C18 chains and from 5 to 40 wt. % of monounsaturated C18 chains by weight of total fatty acid chains. In a further preferred embodiment, the fatty acid chains of the QAC comprise from 20 to 40 wt. %, preferably from 25 to 35 wt. % of saturated C18 chains and from 10 to 35 wt. %, preferably from 15 to 30 wt. % of monounsaturated C18 chains, by weight of total fatty acid chains.

Preferred quaternary ammonium fabric compounds having more than one long carbon chain for use in compositions of the present invention are so called “ester quats”.

Particularly preferred materials are the ester-linked triethanolamine (TEA) quaternary ammonium compounds comprising a mixture of mono-, di- and tri-ester linked components.

Typically, TEA-based fabric softening compounds comprise a mixture of mono, di- and tri ester forms of the compound where the di-ester linked component comprises no more than 70 wt. % of the fabric softening compound, preferably no more than 60 wt. % e.g. no more than 55%, or even no more that 45% of the fabric softening compound and at least 10 wt. % of the monoester linked component.

A first group of ester linked quaternary ammonium compounds suitable for use in the present invention is represented by formula (I):

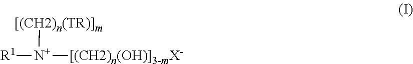

wherein each R is independently selected from a C5 to C35 alkyl or alkenyl group; R1 represents a C1 to C4 alkyl, C2 to C4 alkenyl or a C1 to C4 hydroxyalkyl group; T may be either O—CO. (i.e. an ester group bound to R via its carbon atom), or may alternatively be CO—O (i.e. an ester group bound to R via its oxygen atom); n is a number selected from 1 to 4; m is a number selected from 1, 2, or 3; and X— is an anionic counter-ion, such as a halide or alkyl sulphate, e.g. chloride or methylsulfate. Di-esters variants of formula I (i.e. m=2) are preferred and typically have mono- and tri-ester analogues associated with them. Such materials are particularly suitable for use in the present invention.

Suitable actives include soft quaternary ammonium actives such as Stepantex VT90, Rewoquat WE18 (ex-Evonik) and Tetranyl L1/90N, Tetranyl L190 SP and Tetranyl L190 S (all ex-Kao). Preapagen™ TQL (ex-Clariant), and Tetranyl™ AHT-1 (ex-Kao), (both di-[hardened tallow ester] of triethanolammonium methylsulfate), AT-1 (di-[tallow ester] of triethanolammonium methylsulfate), and L5/90 (di-[palm ester] of triethanolammonium methylsulfate), (both ex-Kao), and Rewoquat™ WE15 (a di-ester of triethanolammonium methylsulfate having fatty acyl residues deriving from 010-C20 and C16-C18 unsaturated fatty acids) (ex-Evonik).

A second group of ester linked quaternary ammonium compounds suitable for use in the invention is represented by formula (II):

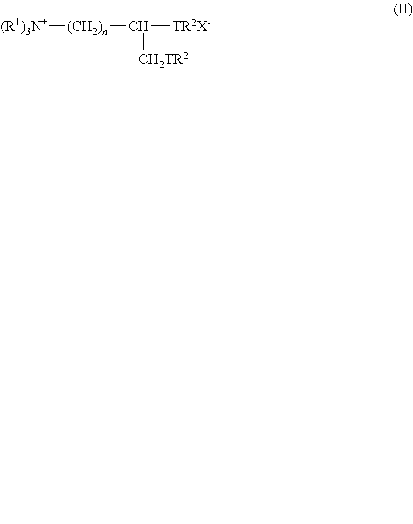

wherein each R1 group is independently selected from C1 to C4 alkyl, hydroxyalkyl or C2 to C4 alkenyl groups; and wherein each R2 group is independently selected from C8 to C28 alkyl or alkenyl groups; and wherein n, T, and X— are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180 (Lever Brothers). Preferably, these materials also comprise an amount of the corresponding mono-ester.

A third group of ester linked quaternary ammonium compounds QACs suitable for use in the invention is represented by formula (III):

(R¹)₂—N*—[(CH₂)ₙ-T-R²]₂X⁻ (III)

wherein each R1 group is independently selected from C1 to C4 alkyl, or C2 to C4 alkenyl groups; and wherein each R2 group is independently selected from C8 to C28 alkyl or alkenyl groups; and n, T, and X— are as defined above. Preferred materials of this third group include bis(2-tallowoyloxyethyl)dimethyl ammonium chloride, partially hardened and hardened versions thereof.

A particular example of the third group of ester linked quaternary ammonium compounds is represented the by the formula (IV):

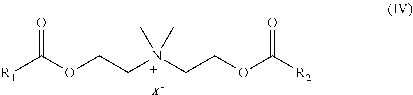

A fourth group of ester linked quaternary ammonium compounds suitable for use in the invention are represented by formula (V)

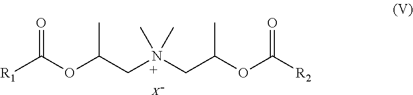

R1 and R2 are independently selected from C10 to C22 alkyl or alkenyl groups, preferably C14 to C20 alkyl or alkenyl groups. X— is as defined above.

The iodine value of the ester linked quaternary ammonium fabric conditioning material is preferably from 0 to 80, more preferably from 0 to 60, and most preferably from 0 to 45. The iodine value may be chosen as appropriate. Essentially saturated material having an iodine value of from 0 to 5, preferably from 0 to 1 may be used in the compositions of the invention. Such materials are known as “hardened” quaternary ammonium compounds. A further preferred range of iodine values is from 20 to 60, preferably 25 to 50, more preferably from 30 to 45. A material of this type is a “soft” triethanolamine quaternary ammonium compound, preferably triethanolamine di-alkylester methylsulfate. Such ester-linked triethanolamine quaternary ammonium compounds comprise unsaturated fatty chains.

If there is a mixture of ester linked quaternary ammonium materials present in the composition, the iodine value, referred to above, represents the mean iodine value of the parent fatty acyl compounds or fatty acids of all of the ester linked quaternary ammonium materials present. Likewise, if there are any saturated ester linked quaternary ammonium materials present in the composition, the iodine value represents the mean iodine value of the parent acyl compounds of fatty acids of all of the ester linked quaternary ammonium materials present.

Iodine value as used in the context of the present invention refers to, the fatty acid used to produce the ester linked quaternary ammonium compounds, the measurement of the degree of unsaturation present in a material by a method of nmr spectroscopy as described in Anal. Chem, 34, 1136 (1962) Johnson and Shoolery.

A suitable fabric softening active is a glyceride. Glycerides are formed from glycerol and one, two or three fatty acid chains. Preferably the glyceride is a triglyceride. Glycerides may be naturally derived in plants or animals or synthetic. Examples of suitable glycerides include castor oil, triglycerides of palm oil, triglycerides of sunflower oil and triglycerides of tallow.

The softening agent may be a clay. A preferred clay is smectite clay. Smectite clays include alkali and alkaline earth metal montmorillonites, saponites and hectorites. There are two distinct classes of smectite-type clays; in the first, aluminium oxide is present in the silicate crystal lattice; in the second class of smectites, magnesium oxide is present in the silicate crystal lattice. The general formulas of these smectites are Al₂ (Si₂O₅)₂(OH)₂ and Mg₃(Si₂O₅)(OH)₂, for the aluminium and magnesium oxide type clay, respectively. Smectites clay mineral containing materials useful in the present invention include dioctahedral and trioctahedral three layer smectite clays, ideally of the calcium and/or sodium montmorillonite type. Most preferably the clay is a bentonite such as a montmorillonite.

The clays used herein are impalpable, i.e., have a particle size which cannot be perceived tactilely. Impalpable clays have particle sizes below about 50 microns; the clays used herein have a particle size range of from about 5 microns to about 50 microns.

Preferably the clays have an ion-exchange capacity of at least 50 meq per 100 grams of clay, generally 70 meq/100 g, and are inpalpable in terms of particle size (from about 5-50 microns).

### Co-Active

The solid fabric softening composition of the present invention comprises co-active. The co-active aids the dissolution of the softening active. Preferably the solid fabric softening composition comprises more than 10 wt. % of composition co-active, more preferably more than 12 wt. % co-active, most preferably more than 15 wt. % co-active. The solid fabric softening composition of the present invention preferably comprise less than 40 wt. % of the composition co-active, more preferably less than 35 wt. % co-active, most preferably less than 25 wt. % co-active. Suitably, solid fabric softening composition may comprise 10 to 40 wt. % co-active, preferably 12 to 35 wt. % co-active and most preferably 15 to 25 wt. % co-active.

Suitable co-active may preferably be selected from non-ionic surfactants, cationic single chain surfactants, polyethylene glycols and combinations thereof. Preferably the co-active is selected from non-ionic surfactants and/or cationic single chain surfactants, most preferably a non-ionic surfactant.

A suitable co-active for use in the present invention is non-ionic surfactants. Suitable non-ionic surfactants include addition products of ethylene oxide and/or propylene oxide with fatty alcohols, fatty acids and fatty amines. Any of the alkoxylated materials of the particular type described hereinafter can be used as the non-ionic surfactant.

Suitable surfactants are substantially water soluble surfactants of the general formula (VII):

R—Y—(C2H4O)z-CH2-CH2-OH (VII)

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g. 14 to 18 carbon atoms.

In the general formula for the ethoxylated non-ionic surfactant, Y is typically:

—O—, —C(O)O—, —C(O)N(R)— or —C(O)N(R)R—

in which R has the meaning given above for formula (VII), or can be hydrogen; and Z is at least about 8, preferably at least about 10 or 11.

Preferably the non-ionic surfactant has an HLB of from about 7 to about 20, more preferably from 10 to 18, e.g. 12 to 16. Genapol™ C200 (Clariant) based on coco chain and 20 EO groups is an example of a suitable non-ionic surfactant.

A class of preferred non-ionic surfactants include addition products of ethylene oxide and/or propylene oxide with fatty alcohols, fatty acids and fatty amines. These are preferably selected from addition products of (a) an alkoxide selected from ethylene oxide, propylene oxide and mixtures thereof with (b) a fatty material selected from fatty alcohols, fatty acids and fatty amines.

A second class of preferred non-ionic surfactants are polyethylene glycol ethers of glycerine. Such as Glycereth-6 Cocoate, Glycereth-7 Cocoate and Glycereth-17 Cocoate. Preferably the non-ionic surfactant is selected from addition products of ethylene oxide and/or propylene oxide with fatty alcohols, fatty acids and fatty amines and polyethylene glycol ethers of glycerine.

Suitable non-ionic surfactants are available commercially as Lutensol™ AT25 ex. BASF based on C16:18 chain and 25 EO groups is an example of a suitable non-ionic surfactant. Other suitable surfactants include Renex 36 (Trideceth-6), ex Croda; Tergitol 15-S3, ex Dow Chemical Co.; Dihydrol LT7, ex Thai Ethoxylate ltd; Cremophor C040, ex BASF and Neodol 91-8, ex Shell; LEVENOL® F-200, LEVENOL® C-301 and LEVENOL® C-201 ex. Kao.

A suitable co-active for use in the present invention is a single chain cationic surfactant. The single chain cationic surfactant preferably has the general formula:

(R₁)₃—N⁺—R₂X⁻

Wherein each R₁ independently comprises 1 to 6 carbon atoms, selected from alky, alkenyl, aryl or combinations thereof. Each R₁ may independently comprise hydroxy groups. Preferably at least two of the R₁ groups correspond to a methyl group.

Wherein R₂ comprises at least 10 carbon atoms. The carbon atoms may be in the form of an alky, alkenyl, aryl or combinations thereof. Preferably the single chain cationic surfactant comprises at least 12 carbon atoms, preferably at least 14 and most preferably at least 16. R₂ may further comprise additional functional groups such as ester groups or hydroxy groups.

X— is an anionic counter-ion, such as a halide or alkyl sulphate, e.g. chloride or methylsulfate

Preferred cationic surfactants include Hydroxyethyl laurdimonium chloride, cetyltrimethylammonium chloride (CTAC), Behentrimonium chloride (BTAC), a Alkyl dimethyl hydroxyethyl ammonium chloride such as Praepagen HY ex Clariant GmbH.

A suitable co-active for use in the present invention is a polyethylene glycol. Preferably the PEG has a molecular weight of less than 2000, more preferably, less than 1000. An example of a suitable PEG is PEG 400.

### Disintegrate System

The solid fabric softening composition described herein preferably comprise a disintegrant system.

The solid fabric softening composition of the present invention preferably comprise more than 10 wt. % of the composition disintegrant system, more preferably more than 12 wt. % disintegrant system, most preferably more than 15 wt. % disintegrant system. The solid fabric softening composition of the present invention preferably comprise less than 40 wt. of the composition disintegrant system, more preferably less than 35 wt. % disintegrant system, most preferably less than 25 wt. % disintegrant system. Suitably, solid fabric softening composition may comprise 10 to 40 wt. % disintegrant system, preferably 12 to 35 wt. % disintegrant system and most preferably 15 to 25 wt. % disintegrant system.

The disintegrant system comprises a combination of salt and acid.

The salt is preferably a water soluble salt. The salt is preferably selected from anhydrous forms or hydrates of salts of mono or divalent alkali metals, preferably anhydrous forms or hydrates of salts of mono alkali metals, more preferably wherein the mono alkali metals is sodium or potassium. Preferably the salt is a carbonate salt.

Preferably, the anhydrous forms or hydrates of salts of mono alkali metals is selected from the group consisting of sodium carbonate, potassium carbonate, sodium hydrogen carbonate, potassium hydrogen carbonate, sodium glycine carbonate, potassium glycine carbonate, sodium bicarbonate, potassium bicarbonate and mixtures thereof.

The preferred ratio of carbonate salt:acid is between 0.75:1 to 1:0.75, more preferably the ratio of carbonate salt to acid is about 1:1. In some embodiments an additional water soluble salt may be present in addition to any carbonate salts present. The secondary water-soluble salt is a non-carbonate salt, such as sodium chloride or potassium chloride. Preferably, any water soluble salt has 5 a solubility of at least 0.5 g/100 mL at 25° C., preferably at least 1 g/100 mL, more preferably at least 5 g/100 mL, even more preferably at least 10 g/100 mL, most preferably at least 10 g/100 mL at 25° C. Preferably, the water soluble salt has a solubility of at most 75 g/100 mL, more preferably at most 70 g/100 mL at 25° C., even more preferably at most 60 g/100 mL. In other words, the water soluble salt has a solubility of in the range of 0.5 g/100 mL to 75 g/100 mL at 25° C., preferably 1 g/100 mL to 70 g/100 mL at 25° C., more preferably 5 g/100 mL to 65 g/100 mL at 25° C., even more preferably 10 g/100 mL to 60 g/100 mL.

Preferably the acid is selected from organic acids. Organic acids may be monovalent or multivalent. Preferably the organic acid is multivalent, i.e. di or tri-valent. Preferably the organic acid comprises 10 or fewer carbon atoms, preferably 6 or fewer. Preferred examples of suitable organic acids include: citric acid, lactic acid, malic acid, succinic acid, tartaric acid, fumaric acid, malonic acid, glutaric acid, maleic acid. Most preferred is citric acid.

In a preferred aspect, the acid is encapsulated. The encapsulation material may be any hydrophobic material, preferably with a melting point between about 40° C. and about 60° C. Suitable materials include wax, oil and water soluble coatings. Preferably oils are used to encapsulate the citric acid, more preferably a vegetable oil. Citric acid encapsulated in plant oils are available from Extrakta Strauss and Anmol Chemicals.

Preferably the total salt and acid are present in a molar ratio of 1:1 to 10:1, more preferably 2.5:1 to 7.5:1, most preferably 4:1 to 6:1.

The disintegrant system may additionally comprise a polymer and/or clay.

Preferably, when a polymer is present in the disintegrant system, the polymer is a polymer which swells on contact with water or one which facilitates water influx and/or efflux by forming channels in the unit dose cleaning composition.

Polymeric components of the disintegrant system are preferably selected from the group consisting of starch and cellulose and derivatives thereof, alginates, sugars, polyvinylpyrrolidones and mixtures thereof. Examples of suitable polymers include starch and cellulose-based materials such as Arbocel (tradename), Vivapur (tradename) both available from Rettenmaier, Nymcel (tradename) available from Metsa-serla, burkeite, methyl cellulose, hydroxypropylcellulose, carboxymethylcellulose, cross-linked celluloses such as cross-linked carboxymethylcellulose (CMC), dextrans, cross-linked polyvinylpyrrolidones. Most preferably, the disintegrant system is microcrystalline cellulose.

Clays suitable for use in the disintegrant system, are preferably selected from modified smectite clays and nano clays. Smectite clays include alkali and alkaline earth metal montmorillonites, saponites and hectorites. There are two distinct classes of smectite-type clays; in the first, aluminium oxide is present in the silicate crystal lattice; in the second class of smectites, magnesium oxide is present in the silicate crystal lattice. The general formulas of these smectites are Al2(Si2O5)2(OH)2 and Mg3(Si2O5)(OH)2, for the aluminium and magnesium oxide type clay, respectively. Smectites clay mineral containing materials useful in the present invention include dioctahedral and trioctahedral three layer smectite clays, ideally of the calcium and/or sodium montmorillonite type. Most preferably the clay is a bentonite such as a montmorillonite. Commercial examples of suitable clays include clays marketed under the trade name Pelben ex. Buntech, Laundrosil ex. Clariant and halloysite (widely available).

Where present the polymer and/or clay preferably has a particle size distribution such that at least 90% by weight thereof has a particle size below 0.3 mm and at least 30% by weight thereof has a particle size below about 0.2 mm, preferably a particle size distribution such that at least 90% by weight thereof has a particle size below about 0.25 mm and at least 50% by weight thereof has a particle size below about 0.2 mm, more preferably the polymer and/or clay has a particle size distribution such that at least 90% by weight thereof has a particle size above about 0.05 mm, preferably above about 0.075 mm.

The particles size distribution of the polymeric disintegrant system can suitably be determined by means of sieving in oil, i.e. by employing a set of sieves of different mesh sizes and by dispersing the cell wall material into a sufficient quantity of oil before sieving. This same technique can be used to determine the particle size distribution of other non-fat particulate components of the oil-continuous composition.

In one aspect of the present invention, the fabric softening active may be pre dispersed on the disintegrant system materials. This may be particularly preferred when a clay is present, a particularly preferred clay is nano clays such as halloysite.

### Perfume

The solid fabric softening composition of the present invention may comprise perfume materials. The compositions suitably comprise 0.1 to 35 wt. % perfume materials i.e. free perfume and/or perfume microcapsules, by weight of the composition. As is known in the art, free perfumes and perfume microcapsules provide the consumer with perfume hits at different points during the wash cycle. It is particularly preferred that the compositions of the present invention comprise a combination of both free perfume and perfume microcapsules.

Preferably the composition of the present invention comprises 0.5 to 25 wt. % perfume materials.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

### Free Perfumes:

The compositions of the present invention preferably comprise 2 to 20 wt. % free perfume by weight of the composition, more preferably 4 to 15 wt. % free perfume.

Particularly preferred perfume components are blooming perfume components and substantive perfume components. Blooming perfume components are defined by a boiling point less than 250° C. and a Log P or greater than 2.5. Substantive perfume components are defined by a boiling point greater than 250° C. and a Log P greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

### Perfume Microcapsules:

The compositions of the present invention preferably comprise 0.5 to 15 wt. % perfume microcapsules by weight of the composition, more preferably 1 to 10 wt. % perfume microcapsules. The weight of microcapsules is of the material as supplied.

When perfume components are encapsulated, suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The compositions of the present invention preferably comprises friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a Log P greater than 2.5. Substantive perfume components are defined by a boiling point greater than 250° C. and a Log P greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume components may be applied.

The microcapsules may comprise perfume components and a carrier for the perfume ingredients, such as zeolites or cyclodextrins.

### Antifoam

The solid fabric softener compositions may preferably comprise an antifoam or suds suppressing material. Suitable antifoam materials are preferably in granular form for use in solid fabric conditioner compositions, such as those described in EP 266863A (Unilever). Preferably antifoam materials may be selected from silicone oil, petroleum jelly, hydrophobic silica and fatty acids, more preferably silicone oil and fatty acids. Antifoam may be present in an amount up to 5% by weight of the composition. Preferably the solid fabric conditioner composition according to the present invention includes from 0.2 wt. % to 5 wt. % antifoam, preferably 0.5 wt. % to 5 wt. %.

### Filler

The solid fabric conditioner compositions may preferably comprise soluble and/or insoluble filler. Preferably the filler is insoluble. The filler provides beneficial properties such as improving the flow of the powder and providing a carrier for any liquid ingredients. When selecting a suitable filler, consideration must be made to the desirable pH of the composition suitable filler materials include: silica, metal oxides, attapulgite, sodium sulphate, sodium acetate or sodium chloride.

Preferably the solid fabric conditioner compositions comprise 5 to 70 wt. % filler. More preferably 10 to 60 wt. %.

### Other Ingredients

The solid fabric softening compositions of the present invention may comprise other ingredients of fabric conditioner as will be known to the person skilled in the art. Among such materials there may be mentioned: salts, insect repellents, shading or hueing dyes, pH buffering agents, perfume carriers, hydrotropes, anti-redeposition agents, soil-release agents, polyelectrolytes, anti-shrinking agents, anti-wrinkle agents, anti-oxidants, dyes, colorants, sunscreens, anti-corrosion agents, drape imparting agents, anti-static agents, sequestrants and ironing aids. The products of the invention may contain pearlisers and/or opacifiers. A preferred sequestrant is HEDP, an abbreviation for Etidronic acid or 1-hydroxyethane 1,1-diphosphonic acid.

pH

The solid fabric softening compositions of the present invention preferably has an acidic pH when diluted with water. i.e. a pH of less than 7. Preferably the pH is in the range of 1.5 to 6, more preferably 1.5 to 4.5. The pH of the powder is measured by diluting a sample of the powder with water in a 1:5 weight ratio and using a pH probe to measure the resulting pH of the solution.

### Form of the Invention

The solid fabric softening compositions may be provided in any solid form, for example a powder or a tablet. The preferred form of the present invention is tablets. Tablets may be formed according to standard tablet formation methods. e.g. by compression of powders.

The fabric softening tablets preferably has a weight of 3 to 10 g, more preferably a weight of 5 to 8 g. The density of the tablet is preferably 1.25 to 1.75 g/cm³, more preferably 1.35 to 1.65 g/cm³. Having this weight and density the tablet is of the right proportions to efficiently dissolve in a standard rinse compartment of a washing machine drawer.

The fabric softening tablets may be prepared by a method comprising the steps of;
i. Melting the fabric softener active and co-active in a pre-melt
ii. Combining the pre-melt with the disintegrant
iii. Compressing the resulting powder into a tablet.

In more detail, the method may include forming a co-melt of the softener active and co-active. The co melt is preferably prepared at a temperature above 50° C., more preferably above 55° C. and most preferably above 60° C. Where present, any free oil or perfume microcapsules are dry mixed with the disintegrant materials. The dry mix and co-melt are then combined. Any additional ingredients may be added at this stage. The resulting powder is then pressed into a tablet.

The fabric softening tablets preferably comprises less than 10 wt. % of the composition water. Preferably less than 5 wt. % and more preferably less than 1 wt. %. In other words, the fabric softening tablets comprise 0 to 10 wt. % of the composition water, preferably 0 to 5 wt. % and more preferably 0 to 1 wt. % water.

### Method of Use

The solid fabric softening compositions, preferably tablets, as described herein may be used in a method of softening clothes, wherein a fabric softening table, are placed in the rinse drawer of an automatic washing machine.

The solid fabric softening compositions, preferably tablets, as described herein may be used to soften fabric during the rinse stage of the laundry process.

### Examples

The following fabric softening compositions, in the form of a tablet, may be prepared as follows:

TABLE 1
Example composition

| Ingredient | Wt. % of the composition | | | | | | | |
|---|---|---|---|---|---|---|---|---|
| Quaternary | 47 | 47 | — | — | 35 | 35 | — | — |
| ammonium | | | | | | | | |
| compounds | | | | | | | | |
| having more | | | | | | | | |
| than one long | | | | | | | | |
| carbon chain¹ | | | | | | | | |
| Cationic | — | — | 45 | 45 | — | — | 35 | 35 |
| polymer² | | | | | | | | |
| Non-ionic | 19 | — | 23 | — | 15 | — | 15 | — |
| surfactant³ | | | | | | | | |
| Single chain | — | 19 | — | 23 | — | 15 | — | 15 |
| cationic | | | | | | | | |
| surfactant⁴ | | | | | | | | |
| Salt⁵ | 5 | 5 | 5 | 5 | 15 | 15 | 15 | 15 |
| Acid⁶ | 1 | 1 | 1 | 1 | 5 | 5 | 5 | 5 |
| Polymer⁷ | 4 | 4 | 4 | 4 | 20 | 20 | 20 | 20 |
| Perfume | 5 | 5 | 5 | 5 | 2.5 | 2.5 | 2.5 | 2.5 |
| microcapsules | | | | | | | | |
| Free oil | 10 | 10 | 10 | 10 | 7.5 | 7.5 | 7.5 | 7.5 |
| perfume | | | | | | | | |
| Filler | 9 | 9 | 9 | 9 | — | — | — | — |
| pH adjuster | 0.3 | 0.3 | 0.3 | 0.3 | — | — | — | — |
| Total | 100 | 100 | 100 | 100 | 100 | 100 | 100 | 100 |

Quaternary ammonium compounds having more than one long carbon chain¹—Tetranyl AO-1 ex. Kao chemicals

Cationic polymer²—QUATIN 350 ex Cosun Biobased products.

Non-ionic surfactant³—Levenol F200 ex. Kao

Single chain cationic surfactant⁴—Praepagen HY ex. Clariant

Salt⁵—Sodium carbonate

Acid⁶—Citric acid encapsulated in vegetable oil ex. Taste Tech solutions

Polymer⁷—Microcrystalline cellulose

The example fabric softening tablet may be prepared by co-melting the softener active and co-active at 60° C. and cooling to room temperature. Separately the perfume microcapsules, free oil perfume and disintegrant mix may be combined. The cooled pre-melt can then be added to the powder along with the pH adjuster. The resulting powder can be compressed to tablet form under a compression of 10 kg/cm².

1. A solid fabric softening composition comprising:
a. 25 to 70 wt. % Fabric softening active;
b. 10 to 40 wt. % Co-active; and
c. 10 to 40 wt. % Disintegrant system;
Wherein the disintegrant system comprises salt and acid.

2. A solid fabric softening composition according to claim 1, wherein the composition is in the form of a tablet.

3. A solid fabric softening composition according claim 2, wherein the fabric softener tablet has a weight of 3 to 10 g.

4. A fabric softener tablet according to claim 2, wherein the fabric softener tablet has a density of 1.25 to 1.75 g/cm³.

5. A solid fabric softening composition according to claim 1, wherein the composition further comprises perfume ingredients selected from free oil perfume and/or perfume microcapsules.

6. A solid fabric softening composition according to claim 1, wherein the acid in the disintegrant system is encapsulated.

7. A method of producing a fabric softening tablet according to claim 2, the method comprising the steps of;
i. Melting the fabric softener active and co-active in a pre-melt;
ii. Combining the pre-melt with the disintegrant system; and
iii. Compressing the resulting powder into a tablet.

8. A method of softening clothes, wherein a solid fabric softening composition according to claim 1, is placed in the rinse drawer of an automatic washing machine.

9. Use of a solid fabric softening composition according to claim 1, wherein the composition is used to soften fabrics during the rinse stage of the laundry process.
